(19) United States
(12) Patent Application Publication
(10) Pub. No.: US 2023/0342483 A1
(43) Pub. Date: Oct. 26, 2023

(54) AUDIT APPARATUS AND AUDIT METHOD

(71) Applicant: NOMURA RESEARCH INSTITUTE, LTD., Tokyo (JP)

(72) Inventors: Jun HASHIMOTO, Tokyo (JP); Jiawei LIU, Tokyo (JP)

(21) Appl. No.: 17/940,164

(22) Filed: Sep. 8, 2022

(30) Foreign Application Priority Data
Apr. 26, 2022 (JP) 2022-072054

(51) Int. Cl. G06F 21/62; G06F 16/535

(52) U.S. Cl. CPC G06F 21/6218; G06F 16/535; G06V 10/95

(57) ABSTRACT

An audit apparatus stores image data indicating a screen displayed on a user terminal when the user terminal accesses a server. The audit apparatus inputs the stored image data to a function approximation device created by using a predetermined detection target image as learning data, and detects that the detection target image is included in the image data in a case where the detection target image is included in the image data. The audit apparatus stores an audit log including detection results for the detection target image.

### BACKGROUND

### 1. Field

The present disclosure relates to a data processing technique, and in particular, to an audit apparatus and an audit method.

### 2. Description of the Related Art

There are many pieces of software (hereinafter, also referred to as “audit support software”) that control user's access to important systems from the viewpoint of security and store logs at the time of access. Some audit support software stores an operation of a user at the time of accessing an important system in a moving image format in order to ensure traceability at the time of the occurrence of a security incident. The audit support software is roughly divided into an agent type in which an application called an agent is introduced into a client or a server and a gateway type in which a device that mediates communication between the client and the server is provided.
Patent Literature 1: JP 2005-295486 A

The gateway type audit support software has an advantage that the influence on a client or a server is small, but it is difficult to acquire information (character string information or the like) accompanying an image (moving image or the like) as an audit trail indicating an access status. Therefore, in the case of using the gateway type audit support software, it is not easy for an auditor to find out that an operation (for example, an unauthorized operation) satisfying a certain condition has been performed from the image as an audit trail.

In the case of the agent type audit support software, a function of acquiring information accompanying an image as an audit trail indicating an access status can be installed in the agent application. However, introduction of the agent application having such a function has a large influence on the environment (for example, apparatuses such as a client and a server), and it may be difficult to introduce the agent application.

### SUMMARY

The technique of the present disclosure has been made in view of such problems, and an object thereof is to provide a technique for supporting detection of an operation satisfying a certain condition from an image recorded as an audit trail.

In order to solve the above problem, according to an aspect of the present disclosure, there is provided an audit apparatus including: an image storage unit that stores image data indicating a screen displayed on a first apparatus when the first apparatus accesses a second apparatus; a detection unit that inputs the image data stored in the image storage unit to a function approximation device created by using a predetermined detection target image as learning data, and detects that the detection target image is included in the image data in a case where the detection target image is included in the image data; and an audit log storage unit that stores an audit log including detection results for the detection target image from the detection unit.

According to another aspect of the present disclosure, there is provided an audit method. This method executed by a computer includes: storing image data indicating a screen displayed on a first apparatus when the first apparatus accesses a second apparatus; inputting image data stored in the storing to a function approximation device created by using a predetermined detection target image as learning data, and detecting that the detection target image is included in the image data in a case where the detection target image is included in the image data; and storing an audit log including detection results for the detection target image in the detecting.

It should be noted that any combinations of the above constituents and those obtained by converting expressions of the present disclosure between a system, a computer program, a recording medium storing the computer program, and the like are also effective as aspects of the present disclosure.

### BRIEF DESCRIPTION OF THE DRAWINGS

FIG. 1 is a diagram illustrating a configuration of a communication system according to an embodiment;

FIG. 2 is a block diagram illustrating functional blocks of an audit apparatus in FIG. 1;

FIG. 3 is a diagram illustrating details of a plurality of types of logs stored in the audit apparatus;

FIG. 4 is a flowchart illustrating operation of the audit apparatus;

FIG. 5 is a diagram illustrating an example of an operation moving image frame;

FIG. 6 is a diagram illustrating an example of an audit moving image frame;

FIG. 7 is a diagram illustrating an example of an audit processing log; and

FIG. 8 is a diagram illustrating an example of an alert message.

### DETAILED DESCRIPTION

The invention will now be described by reference to the preferred embodiments. This does not intend to limit the scope of the present invention, but to exemplify the invention.

First, an outline of an audit apparatus according to an embodiment will be described. In general, in a case where a trail of access to an important server or the like is recorded as an image (moving image or the like), it is difficult to detect from image data that an operation satisfying a certain condition has been performed. The operation satisfying a certain condition includes an unauthorized operation, and includes, for example, activation of an unauthorized application and display of unapproved information.

In order to detect the above operation, it has been necessary to introduce a certain agent application into one or both of a client side and a server side, record information accompanying an image, and monitor the accompanying information. The accompanying information is, for example, character string information indicating the activated application or character string information input to a screen. However, it is difficult for the gateway type audit support software (which may also be referred to as an access control program) to acquire the accompanying information.

The audit apparatus according to the embodiment is a gateway type apparatus, and uses an object detection algorithm of machine learning to detect that a user has performed an operation satisfying a certain condition from an image serving as an access trail to an important server or the like. According to the audit apparatus of the embodiment, it is possible to realize efficient and accurate auditing based on an image as an access trail while providing a gateway type advantage that the influence on a client and a server is small. In the embodiment, image data of an access trail and image data of an audit result are moving image data, but as a modification example, may be still image data or a combination of moving image data and still image data.

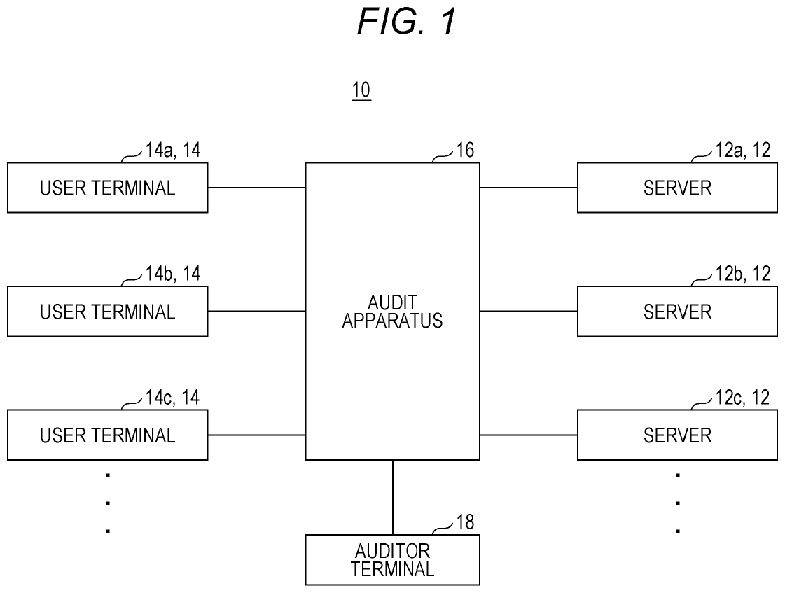

FIG. 1 illustrates a configuration of a communication system 10 according to an embodiment. The communication system 10 is an information processing system constructed in a company. The communication system 10 includes a plurality of servers 12, a plurality of user terminals 14, an audit apparatus 16, and an auditor terminal 18. The apparatuses in FIG. 1 are connected to each other via a communication network including a LAN, a WAN, and the Internet.

The plurality of servers 12 are important information processing apparatuses requiring high security in a company, and include a server 12a, a server 12b, and a server 12c. The plurality of servers 12 may include a file server, a web server, and a virtual server on a cloud.

The plurality of user terminals 14 are information processing apparatuses operated by different users, and include a user terminal 14a, a user terminal 14b, and a user terminal 14c. The users are users of the servers 12, and are, for example, employees of a company. Each of the plurality of user terminals 14 may be a computer, a smartphone, or a tablet terminal.

The auditor terminal 18 is an information processing apparatus operated by an auditor who is required to audit whether an operation satisfying a certain condition has been performed on the server 12. The auditor terminal 18 may be a computer, a smartphone, or a tablet terminal.

The audit apparatus 16 is an information processing apparatus in which the gateway type audit support software is installed. The audit apparatus 16 controls access from the user terminal 14 to the server 12, and supports the audit as to whether there is unauthorized access from the user terminal 14 to the server 12.

In the embodiment, remote desktop client software is introduced into the user terminal 14, and the user terminal 14 accesses the server 12 via a remote desktop protocol (RDP). The server 12 provides the user terminal 14 with image data (for example, bitmap data) indicating a screen of the user. The audit apparatus 16 receives the image data indicating the screen of the user transmitted from the server 12, and transfers the image data to the user terminal 14.

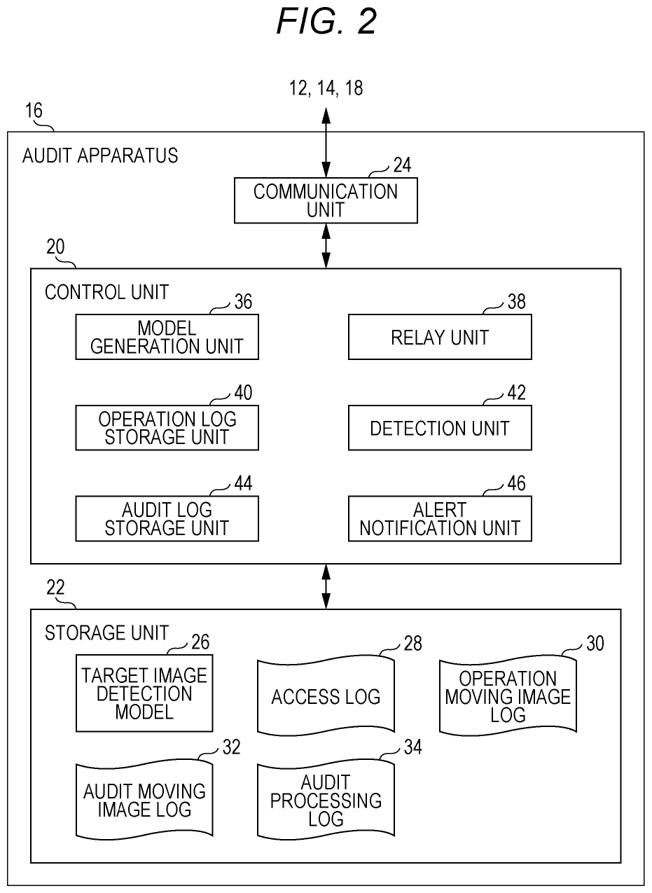

FIG. 2 is a block diagram illustrating functional blocks of the audit apparatus 16 in FIG. 1. Each block illustrated in the block diagram of the present specification can be realized by elements including a processor, a CPU, and a memory of a computer, an electronic circuit, and a mechanical device in terms of hardware, and is realized by a computer program or the like in terms of software, but here, functional blocks realized by cooperation of these are illustrated. Therefore, those skilled in the art will understand that these functional blocks can be realized in various forms by a combination of hardware and software.

The audit apparatus 16 includes a control unit 20, a storage unit 22, and a communication unit 24. The control unit 20 executes various types of data processing related to access control and auditing. The storage unit 22 stores data to be referred to or updated by the control unit 20. The communication unit 24 communicates with an external device according to a predetermined communication protocol. The control unit 20 transmits and receives data to and from the server 12, the user terminal 14, and the auditor terminal 18 via the communication unit 24.

The storage unit 22 stores a target image detection model 26, an access log 28, an operation moving image log 30, an audit moving image log 32, and an audit processing log 34. In other words, the storage unit 22 includes a first storage unit that stores the target image detection model 26, a second storage unit that stores the access log 28, a third storage unit that stores the operation moving image log 30, . . . .

The target image detection model 26 is data of a function approximation device created through machine learning using a predetermined detection target image as learning data, and is data of a function approximation device that detects a detection target image from an input image. The target image detection model 26 of the embodiment receives an input of image data, and outputs a type and a position of a detection target image detected from the image data, and a detection probability value (a value of certainty). The target image detection model 26 may be realized as a function approximation device (in other words, a machine learning model) in various aspects, and may be, for example, a neural network or a support vector machine.

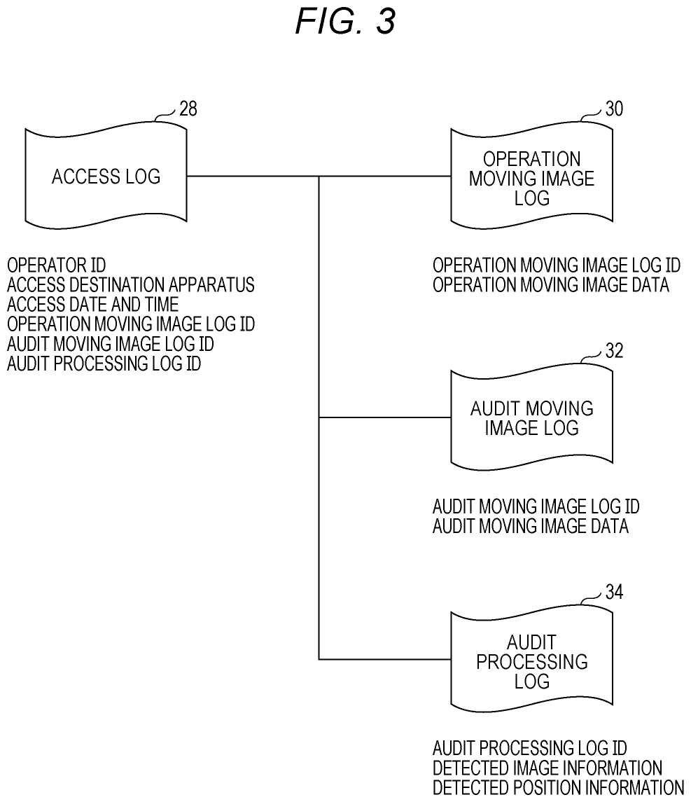

FIG. 3 illustrates details of a plurality of types of logs stored in the audit apparatus 16. The access log 28 is data in which information regarding access from the user terminal 14 to the server 12 is recorded. The information recorded in the access log 28 includes an operator ID (for example, a login ID of a user to the audit apparatus 16), an access destination apparatus (identification information of the server 12), an access date and time, an ID of the operation moving image log 30, an ID of the audit moving image log 32, and an ID of the audit processing log 34.

The operation moving image log 30 includes an operation moving image log ID and operation moving image data. The operation moving image data is moving image data indicating a screen displayed on the user terminal 14 and stored when the user terminal 14 accesses the server 12. In other words, the operation moving image data is moving image data indicating an operation performed on the server 12 by the user who has accessed the server 12.

The audit moving image log 32 and the audit processing log 34 may also be collectively referred to as an audit log. The audit moving image log 32 includes an audit moving image log ID and audit moving image data. The audit moving image data is moving image data indicating detection results for a detection target image from the operation moving image data from the detection unit 42 that will be described later.

The audit processing log 34 is log data in which information regarding the detection result of the detection target image from the operation moving image data by the detection unit 42 is recorded. The audit processing log 34 includes an audit processing log ID, detected image information, and detected position information. The detected image information includes the name or identification information of the detection target image detected from the operation moving image data. The detected position information is information indicating a detected position of the detection target image from the operation moving image data. For example, the detected position information may include information indicating a temporal position (in other words, a frame position) at which the detection target image is displayed in the operation moving image data. The detected position information may include information indicating a spatial position (for example, coordinates) at which the detection target image is displayed in the operation moving image data.

In the embodiment, the access log 28 includes an operation moving image log ID, an audit moving image log ID, and an audit processing log ID. In the embodiment, the access log 28, the operation moving image log 30, the audit moving image log 32, and the audit processing log 34 have a one-to-one relationship with each other. The access log 28, the operation moving image log 30, the audit moving image log 32, and the audit processing log 34 may be associated on a one-to-one basis on the basis of information other than the ID. For each access from the user terminal 14 to the server 12 via the audit apparatus 16, the access log 28, the operation moving image log 30, the audit moving image log 32, and the audit processing log 34 corresponding to the access are generated.

Returning to FIG. 2, the control unit 20 includes a model generation unit 36, a relay unit 38, an operation log storage unit 40, a detection unit 42, an audit log storage unit 44, and an alert notification unit 46. The functions of the plurality of functional blocks may be installed in the gateway type audit support software. The audit support software may be installed in the storage of the audit apparatus 16 via a recording medium or a network. A processor (a CPU or the like) of the audit apparatus 16 may realize the functions of the plurality of functional blocks by reading the audit support software into a main memory and executing the audit support software.

An operation of the communication system 10 having the above configuration will be described.

A developer of the communication system 10 creates learning data (which may be referred to as teacher data or training data) for creating the target image detection model 26. The learning data includes a plurality of sets (actually, several hundred sets to several thousand sets) of image data (hereinafter, also referred to as “learning image data”) including a detection target image and label data. The label data includes identification information (for example, a name) of the detection target image and information indicating a position where the detection target image is disposed in the learning image data. The information indicating the position where the detection target image is disposed may include, for example, ordinates and abscissas of the center of the detection target image, and a width and a height of the detection target image.

The detection target image is an image that can be displayed on the user terminal 14 when the server 12 is accessed, and includes an image indicating that an operation causing the occurrence of the security incident has been performed. As the detection target image, any image can be set for each entity (company or the like) that introduces the audit apparatus 16. The detection target image of the embodiment includes both an image (hereinafter, also referred to as a “specific application image”) displayed on the user terminal 14 when a predetermined application is executed and an image (hereinafter, also referred to as a “sensitive information image”) including predetermined sensitive information. As a modification example, the detection target image may include only one of the specific application image and the sensitive information image.

The specific application image may include, for example, (1) an image of a terminal application (also referred to as a terminal emulator or a remote logon client), (2) an image of a spreadsheet application, and (3) an image of a specific webpage. (3) The image of the specific webpage may be, for example, an image of a webpage of a management console of the server 12. The sensitive information is information that requires careful handling from the viewpoint of information security. The sensitive information image may include, for example, an image indicating personal information or an image of a customer list.

The model generation unit 36 of the audit apparatus 16 generates the target image detection model 26 through machine learning using the learning data including the detection target image, and stores the target image detection model 26 in the storage unit 22. A well-known technique may be used to generate the target image detection model 26 based on the learning data including the detection target image. In the embodiment, the model generation unit 36 generates the target image detection model 26 by using a library of You Only Look Once (YOLO) v5 which is well-known object detection software. For example, the model generation unit 36 may generate the target image detection model 26 by designating the learning data (the learning image data and the label data) as parameters and executing the function “train.py” provided by YOLO v5.

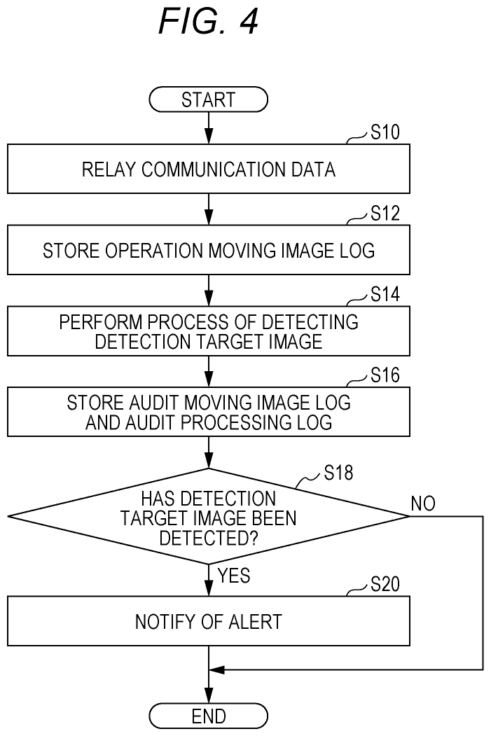

FIG. 4 is a flowchart illustrating an operation of the audit apparatus 16. The relay unit 38 of the audit apparatus 16 is connected to the user terminal 14 as a remote desktop server, and is connected to the server 12 as a remote desktop client. The relay unit 38 relays communication data exchanged between the user terminal 14 and the server 12 according to the remote desktop protocol (S10).

Specifically, the relay unit 38 receives communication data transmitted from the user terminal 14 and related to an operation input to the screen by the user, and transfers the data to the server 12. The relay unit 38 receives image data (hereinafter, also referred to as “screen data”) that is communication data transmitted from the server 12 and indicates a screen of a user to be displayed on the user terminal 14, and transfers the screen data to the user terminal 14.

The relay unit 38 generates the access log 28 related to access from the user terminal 14 to the server 12, and stores the access log 28 in the storage unit 22. The relay unit may execute ID management, user authentication, and access control which are well-known processes.

The operation log storage unit 40 of the audit apparatus 16 generates moving image data indicating a screen displayed on the user terminal 14 at the time of accessing the server 12 on the basis of the communication data exchanged between the user terminal 14 and the server 12. Specifically, the operation log storage unit 40 generates operation moving image data which is moving image data indicating a plurality of pieces of screen data sequentially provided from the server 12 to the user terminal 14 acquired by the relay unit 38 in a time series. The operation log storage unit 40 stores the operation moving image log 30 in which the operation moving image log ID and the operation moving image data are associated with each other in the storage unit 22 (S12).

The functions of the relay unit 38 and the operation log storage unit 40 may be realized by a function of well-known gateway type audit support software (for example, “SecureCube ACCESS Check” provided by NRI Secure Technologies, Inc).

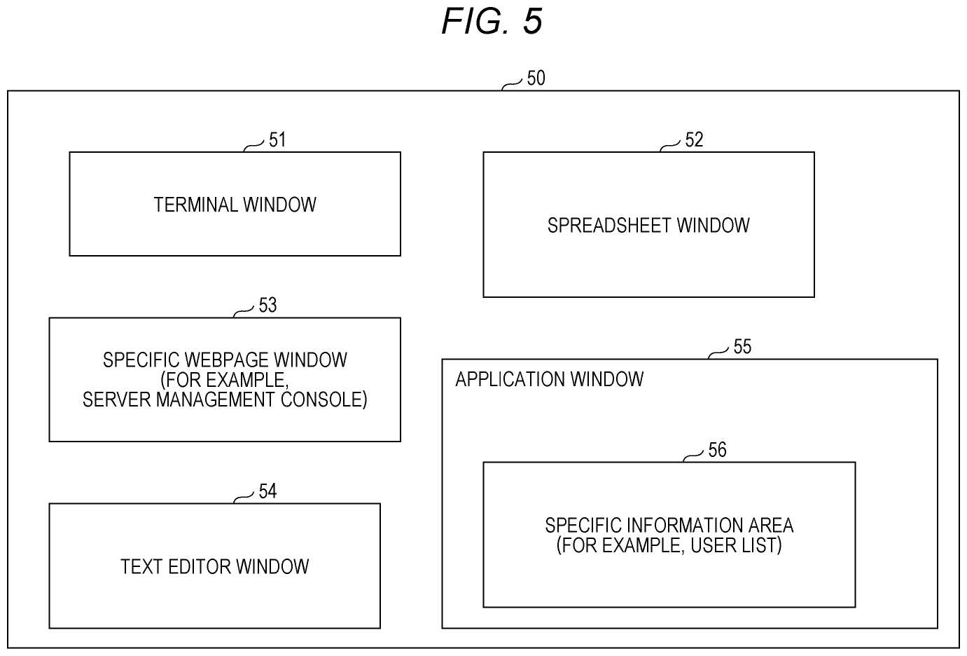

FIG. 5 illustrates an example of the operation moving image frame 50. The operation moving image frame 50 indicates details of one frame (in other words, display details at a certain time point) in the operation moving image data. The operation moving image frame 50 includes a terminal window 51, a spreadsheet window 52, a specific webpage window 53, a text editor window 54, and an application window 55.

The terminal window 51 is an image of a window in which an execution result of a terminal application is displayed. The spreadsheet window 52 is an image of a window in which an execution result of a spreadsheet application is displayed. The specific webpage window 53 is an image of a window in which a webpage including specific content, such as a webpage of the management console of the server 12, is displayed. The text editor window 54 is an image of a window in which an execution result of a text editor is displayed. The application window 55 is an image of a window in which any application is displayed. The application window 55 displays a specific information area 56 (user list in the embodiment) including the sensitive information.

Referring to FIG. 4 again, the processes in S14 to S20 are executed in a case where a predetermined execution timing of an audit support process is reached. The execution timing of the audit support process may be when a predetermined time has elapsed from execution of the previous audit support process, or may be when a new set of the access log 28 and the operation moving image log 30 is stored in the storage unit 22.

In a case where the detection target image is included in the operation moving image data, the detection unit 42 of the audit apparatus 16 detects the detection target image by inputting the operation moving image data of the operation moving image log 30 that is an audit target to the target image detection model 26 (S14). For example, the detection unit 42 may designate the target image detection model 26 and the operation moving image data that is an audit target as parameters and execute the function “detect.py” provided by YOLO v5. In a case where the detection target image is detected from the operation moving image data that is an audit target, the detection unit 42 may acquire a position of the detection target image in the operation moving image data and a probability value of inference (in other words, a value of certainty of detection).

The audit log storage unit 44 of the audit apparatus 16 stores audit logs (the audit moving image log 32 and the audit processing log 34) including the detection result of the detection target image by the detection unit 42 in the storage unit 22 (S16). Specifically, the audit log storage unit 44 stores the audit moving image log 32 in which the audit moving image log ID is associated with the audit moving image data which is moving image data indicating the detection result of the detection target image by the detection unit 42 in the storage unit 22.

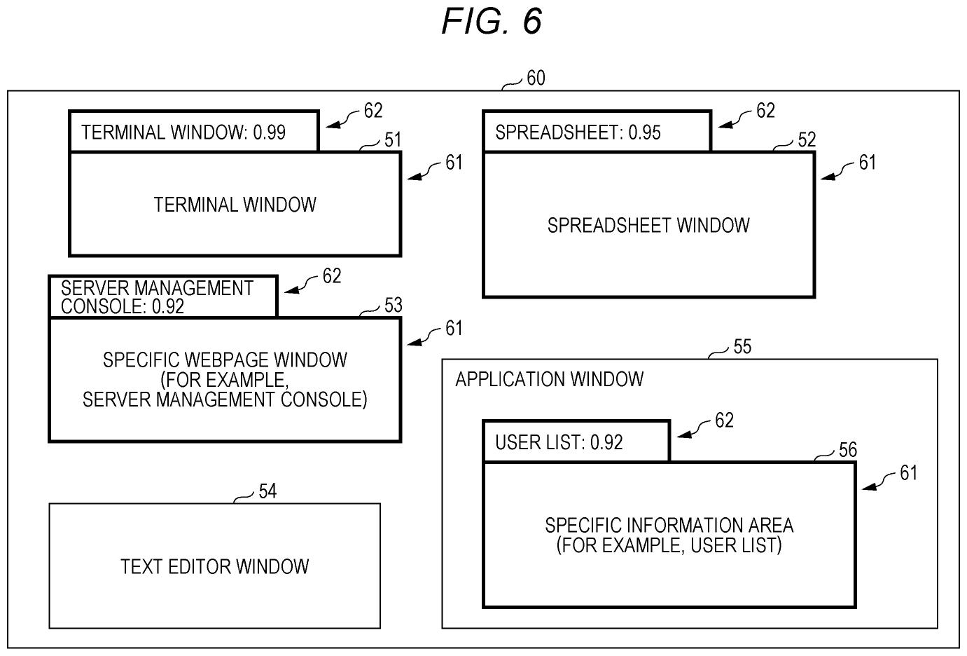

FIG. 6 illustrates an example of an audit moving image frame 60 corresponding to the operation moving image frame 50 in FIG. 5. The audit moving image frame 60 indicates details of one frame in the audit moving image data, in other words, indicates an audit result for display details on the user terminal 14 at a certain time point. The audit log storage unit 44 generates audit moving image data in which a region where the detection target image is detected in the operation moving image data is surrounded by a bounding box 61 and to which detected image information 62 is added. For example, in the bounding box 61 or the detected image information 62, a frame line having a color that easily attracts the attention of the auditor who checks the audit moving image data may be set.

The bounding box 61 can also be said to be an object indicating a position where the detection target image is detected in a moving image. The detected image information 62 includes identification information (for example, a name of an application or information) of the detected image and a probability value of the detection. The process of generating the audit moving image data in which the bounding box 61 and the detected image information 62 are added to the operation moving image data may be realized by using a function provided by YOLO v5.

In the audit moving image frame 60 in FIG. 6, an image of the terminal window 51, an image of the spreadsheet window 52, and an image of the specific webpage window 53 corresponding to a predetermined detection target application are detected, and the bounding box 61 and the detected image information 62 are added to these windows. In the audit moving image frame 60 in FIG. 6, an image of the specific information area 56 corresponding to a predetermined sensitive information area (for example, a user list) is detected, and the bounding box 61 and the detected image information 62 are added to the area.

The audit log storage unit 44 stores the audit processing log 34 which is a text log indicating detection results for the detection target image from the detection unit 42, in the storage unit 22. The audit processing log 34 of the embodiment is a text log in which an audit processing log ID, detected image information, and detected position information are associated.

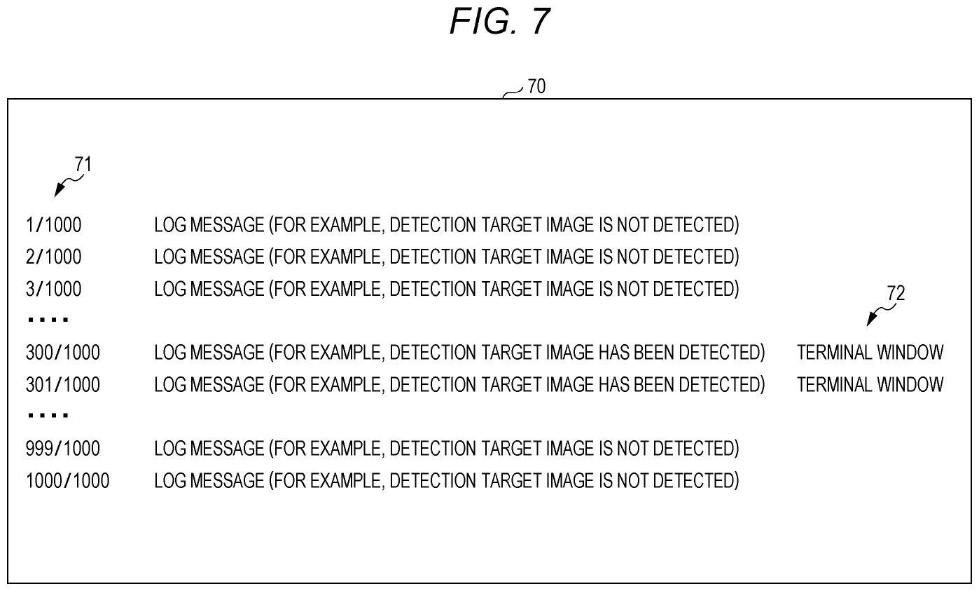

FIG. 7 illustrates an example of the audit processing log 70. The audit processing log 70 in FIG. 7 includes a record for each frame of the operation moving image data. Each record of the audit processing log 70 includes frame position information 71, a log message, and detected image information 72. The frame position information 71 is information indicating a frame position (any frame out of 1000 frames in FIG. 7) in the operation moving image data. In a case where the detection target image is detected, the frame position information 71 is information indicating a detection position of the detection target image. For example, it is assumed that a frame rate of the operation moving image data (or the audit moving image data) is 30 frames per second (FPS), and detection of the detection target image is recorded in the record of the 300th frame. In this case, the auditor can determine that the detection target image is displayed about 10 seconds after the start of the operation moving image data (or the audit moving image data).

The log message includes information indicating whether or not the detection target image is detected. The detected image information 72 is information indicating the type of the detected detection target image. The type of the detection target image may be the type of detection target application indicated by the image, or may be the type of information indicated by the image (for example, a user list or a customer list).

Referring to FIG. 4 again, when the detection unit 42 detects that the detection target image is included in the operation moving image log 30 (operation moving image data) stored in the storage unit 22 (Y in S18), the alert notification unit 46 of the audit apparatus 16 notifies the auditor of an alert message including information regarding the operation moving image log 30 (operation moving image data) (S20). The alert notification unit 46 may transmit text data or image data including the alert message to the auditor terminal 18 and display the alert message on the auditor terminal 18. When the detection target image is not detected from the operation moving image log 30 (operation moving image data) stored in the storage unit 22 (N in S18), the process in S20 is skipped. An alert message notification method is not limited. The alert message notification method may be any of, for example, an e-mail, a short message service (SMS), and a simple network management protocol (SNMP) trap.

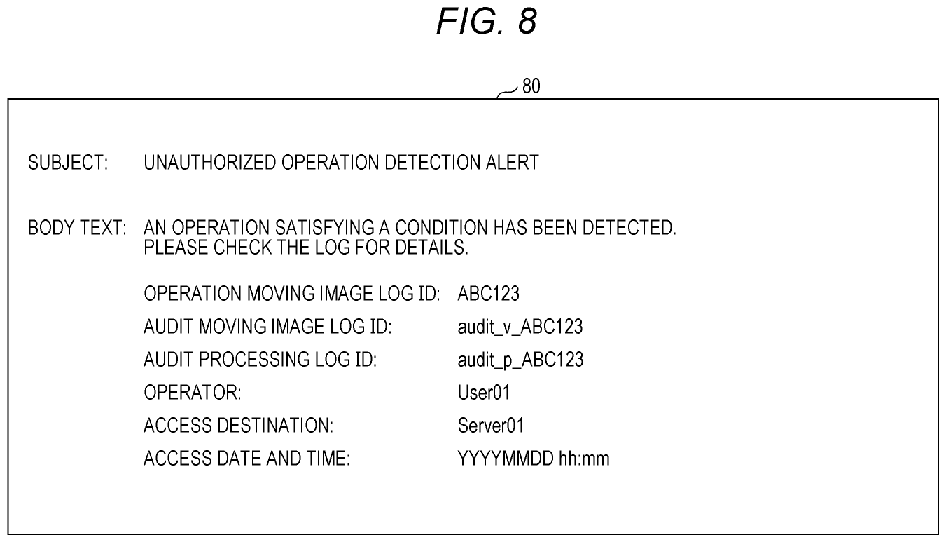

FIG. 8 illustrates an example of an alert message 80. The alert message 80 includes an ID of each piece of log data (an operation moving image log ID, an audit moving image log ID, and an audit process ID), information of an operator (for example, a login ID of a user to the audit apparatus 16), identification information (for example, a host name) of the access destination server 12, and the access date and time. The alert notification unit 46 may extract data to be set in an alert message regarding the certain access from the access log 28 regarding the access.

The audit apparatus 16 according to the embodiment uses an object detection algorithm of machine learning to detect that the user has performed an operation satisfying a certain condition from the operation moving image log 30 serving as an access trail to the server 12. According to the audit apparatus 16, it is possible to realize efficient and accurate auditing based on the operation moving image log 30 as an access trail while providing a gateway type advantage that the influence on an audit target apparatus (the server 12 and the user terminal 14) is small.

Information security of communication system 10 can be improved by using an image displayed when an application requiring attention to security is executed or an image including predetermined sensitive information as the detection target image. Any image can be set for each entity (company or the like) that introduces the audit apparatus 16, and the detection target image may be determined on the basis of the information security policy of each entity.

The audit apparatus 16 stores an audit log (the audit moving image log 32 and the audit processing log 34) indicating a position where the detection target image has been detected in the operation moving image log 30. As a result, it is possible to support an auditor to efficiently audit whether there is an unauthorized operation (for example, activation of an unauthorized application or display of unapproved information) on the user terminal 14. The audit apparatus 16 notifies the auditor that the detection target image has been detected from the operation moving image log 30. As a result, it is possible to support the auditor to improve the efficiency and accuracy of the audit work.

The present disclosure has been described on the basis of the embodiment. It is understood by those skilled in the art that the contents disclosed in the embodiment are examples, that various modification examples can be made to combinations of the constituents and processing processes of the embodiment, and that such modification examples are also within the scope of the present disclosure.

Modification examples will be described. As described above, in the case of the agent type audit support software, a function of acquiring information (character string information or the like) accompanying an image as an audit trail indicating an access status can be installed in an agent application, but introduction of the agent application having such a function has the great influence on an environment (for example, an apparatus such as a client or a server), and thus it may be difficult to introduce the agent application. In order to reduce the influence on the environment, it is also conceivable to introduce an agent application having a compact function of recording only images (moving images and the like) as an audit trail. However, in that case, similarly to the gateway type, it is difficult to acquire information accompanying an image.

Although gateway type audit software is introduced into the audit apparatus 16 of the embodiment, as a modification example, agent type audit support software may be introduced into the audit apparatus 16. The technical idea described in the embodiment is also applicable to a case where agent type audit support software is introduced into the audit apparatus 16. An agent application that records an image indicating a screen displayed on the user terminal 14 may be introduced as an audit trail of access from the user terminal 14 to the server 12 into the server 12 and the audit apparatus 16 of the present modification example. The agent application may generate moving image data (hereinafter, referred to as “operation moving image data”) based on a plurality of pieces of screen data provided from the server 12 to the user terminal 14 according to the remote desktop protocol.

The audit apparatus 16 of the present modification example may include an operation image acquisition unit instead of the relay unit 38. The operation image acquisition unit communicates with one or both of the agent application of the server 12 and the agent application of the user terminal 14. The operation image acquisition unit may acquire image data (operation moving image data in this example) indicating a screen displayed on the user terminal 14 recorded as an audit trail of access from the user terminal 14 to the server 12 from one or both of the agent application of the server 12 and the agent application of the user terminal 14. The operation log storage unit 40 of the audit apparatus 16 may store an operation moving image log including the operation moving image data acquired by the operation image acquisition unit and an ID thereof in the storage unit 22. An operation of the audit apparatus 16 after the operation moving image log is stored may be the same operation as in the embodiment.

According to the present modification example, even in a case where the agent type audit support software is introduced into the audit apparatus 16 and the agent application having a compact function of recording only an image as an access trail is introduced into the server 12 and the user terminal 14, it is possible to realize efficient and accurate auditing based on image data as an access trail by using an object detection algorithm of machine learning, similarly to the embodiment.

In the communication system 10 of the above embodiment or modification example, the audit apparatus 16 is provided as an apparatus separate from an end-to-end communication apparatus (the server 12 and the user terminal 14), but the function of the audit apparatus 16 of the above embodiment or modification example may be installed in the end-to-end communication apparatus (the server 12 or the user terminal 14). In other words, the server 12 or the user terminal 14 may include the audit apparatus 16. The functions of the plurality of functional blocks included in the audit apparatus 16 of the above embodiment or modification example may be installed in a distributed manner in a plurality of information processing apparatuses (including servers on a cloud). In this case, a plurality of information processing apparatuses may cooperate as a system to execute processing similar to that of the audit apparatus 16 of the above embodiment or modification example. For example, as one aspect, the function of the operation log storage unit 40 included in the audit apparatus 16 of the above embodiment may be installed in the server 12 or the user terminal 14, and the function of another functional block included in the audit apparatus 16 of the above embodiment may be installed in the audit apparatus 16.

Any combination of the embodiment and modification examples described above is also useful as embodiments of the present invention. The new embodiments resulting from the combination achieve the effects of each of the combined embodiment and modification examples. It should be understood by those skilled in the art that the functions to be fulfilled by the constituents described in the claims are realized by each of individual constituents or by cooperation of the constituents described in the embodiment and the modification examples.

What is claimed is:

1. An audit apparatus comprising:
an image storage unit that stores image data indicating a screen displayed on a first apparatus when the first apparatus accesses a second apparatus;
a detection unit that inputs the image data stored in the image storage unit to a function approximation device created by using a predetermined detection target image as learning data, and detects that the detection target image is included in the image data in a case where the detection target image is included in the image data; and
an audit log storage unit that stores an audit log including detection results for the detection target image from the detection unit.

2. The audit apparatus according to claim 1, wherein
the detection target image includes at least one of an image displayed when a predetermined application is executed and an image including predetermined sensitive information.

3. The audit apparatus according to claim 1, wherein
the image storage unit stores moving image data indicating a screen displayed on the first apparatus when the second apparatus is accessed, and
the audit log storage unit stores an audit log indicating a position where the detection target image is detected in the moving image data.

4. The audit apparatus according to claim 1, further comprising
a notification unit that notifies an auditor of an alert including information regarding the image data in a case where it is detected that the image data stored in the image storage unit includes the detection target image.

5. An audit method executed by a computer, the audit method comprising:
storing image data indicating a screen displayed on a first apparatus when the first apparatus accesses a second apparatus;
inputting image data stored in the storing to a function approximation device created by using a predetermined detection target image as learning data, and detecting that the detection target image is included in the image data in a case where the detection target image is included in the image data; and
storing an audit log including detection results for the detection target image in the detecting.
